(19) United States
(12) Patent Application Publication
(10) Pub. No.: US 2014/0212253 A1
(43) Pub. Date: Jul. 31, 2014

(54) GRAVITY-FED CURB SIDE DISPENSER

(71) Applicant: GM GLOBAL TECHNOLOGY OPERATIONS LLC, Detroit, MI (US)

(72) Inventor: Wade W. Bryant, Grosse Pointe Farms, MI (US)

(73) Assignee: GM Global Technology Operations LLC, Detroit, MI (US)

(21) Appl. No.: 13/754,066

(22) Filed: Jan. 30, 2013

(51) Int. Cl. B60P 1/43

(52) U.S. Cl. CPC B60P 1/43
USPC 414/470; 414/813

(57) ABSTRACT

A number of variations of the invention may include a product comprising a vehicle including a cargo area, the vehicle comprising at least one of a titled unloading stage in the cargo area or at least one inclined ramp surface in the cargo area.

### TECHNICAL FIELD

The field to which the disclosure generally relates to includes vehicles, containers, and systems for delivering cargo and methods of using the same.

### BACKGROUND

Multi-stop delivery trucks that pick up and return cargo along the route struggle with the need to simultaneously unload and reload their trucks from a single loading point. The common solution is to provide an aisle away in the cargo area to allow cargo to be moved around other cargo during the process.

### SUMMARY OF ILLUSTRATIVE VARIATIONS OF THE INVENTION

A number of variations of the invention may include a product comprising a vehicle including a cargo area, the vehicle comprising at least one of a titled unloading stage in the cargo area or at least one inclined ramp surface in the cargo area, the at least one inclined ramp surface being constructed and arranged to allow cargo containers to slide or move along the at least one inclined ramp surface from the rear of the cargo area towards the front of the cargo area, and wherein the tilted unloading stage is constructed and arranged to allow containers to be moved down the tilted unloading stage and unloaded from the vehicle.

A number of variations of the invention may include a product comprising a cargo container including a first side and an opposite second side, a third side and an opposite fourth side, an inclined support feature formed on lower load surfaces of the container at a location between the third side and the forth side and constructed and arranged for mating with an inclined ramp surface in a cargo area of a vehicle.

A number of variations of the invention may include a sliding or moving cargo containers along the at least one inclined ramp surface from the rear of the cargo area toward the front of the cargo area, or moving cargo containers down the tilted unloading stage and unloading the cargo containers from the vehicle.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a plan view of a vehicle according to a number of variations of the invention showing at least one path of movement for cargo containers onto and off of the vehicle.

FIG. 2 is a schematic side view with portions removed of a vehicle including at least one inclined ramp surface and a plurality of containers each having an inclined support feature on a lower load surface to allow the cargo container to slide along the inclined ramp surface according to a number of variations of the invention.

FIG. 3 is an exploded view of a portion of FIG. 2.

FIG. 4 is a schematic sectional view looking toward the rear of vehicle and illustrating a tilted unloading stage in the cargo area of the vehicle, and a pivotally connected ramp operatively connected to the tilted unloading stage in a method of unloading cargo containers there from according to a number of variations of the invention.

### DETAILED DESCRIPTION OF ILLUSTRATIVE VARIATIONS OF THE INVENTION

The following description of the variations is merely illustrative in nature and is in no way intended to limit the invention, its application, or uses.

A number of variations of the invention include a product including a vehicle having a gravity-fed side dispenser, wherein the vehicle cargo area is constructed and arranged to load containers on at least one inclined ramp surface and wherein the containers slide down the at least one inclined ramp surface and are unloaded from a side of the vehicle. In a number of variations of the invention the gravity-fed side dispenser may include a titled unloading stage.

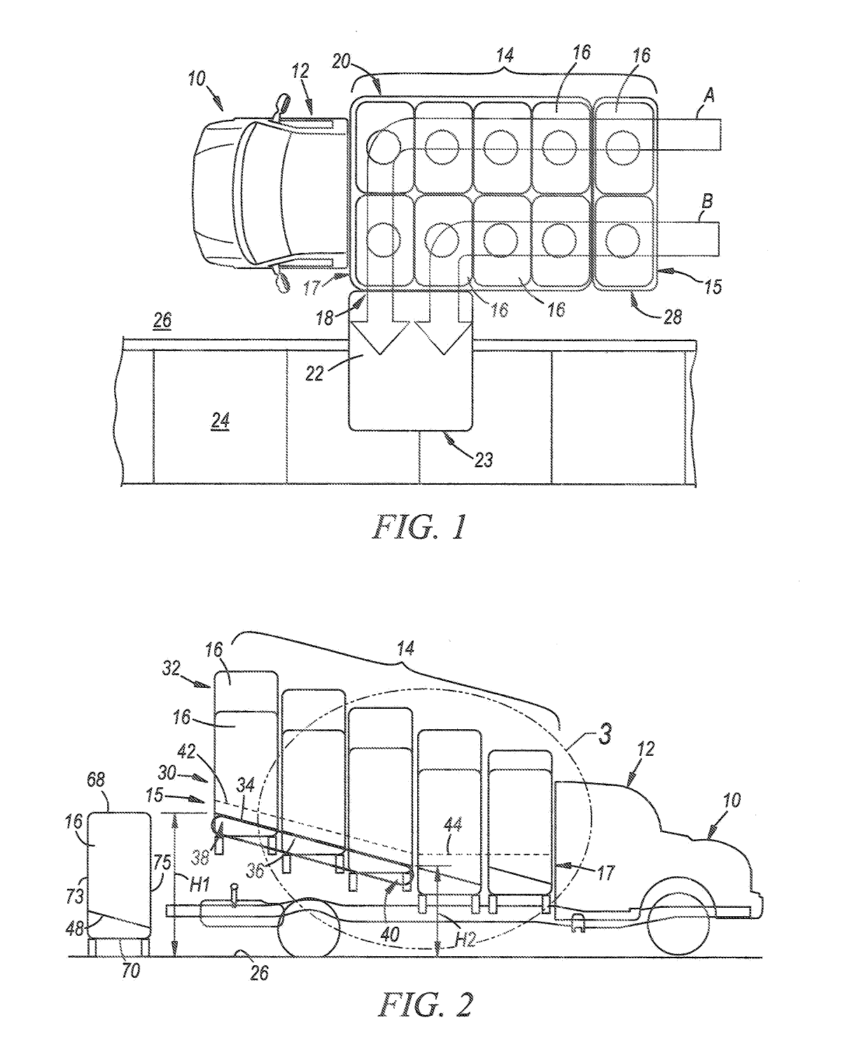

A number of variations of the invention are illustrated by FIG. 1 and may include a product including a vehicle 10 including a vehicle operator cab 12 and a cargo area 14. A plurality of cargo containers 16 may be loaded in the cargo area 14 so that the cargo containers 16 may move as indicated by arrows A and B from the rear 15 of the cargo area toward the front 17 of the cargo area and may be dispensed from a first side 18 or a second side 20 of the vehicle 10. In a number of variations of the invention a side ramp 22 may be provided to assistant in unloading the cargo containers 16 onto the ground or a surface such as a sidewalk 24 or thoroughfare 26. The side ramp 22 may be positioned adjacent an unloading stage 46 (shown in FIG. 4) and may have a free end 23 for supporting the side ramp 22 on the ground or other surface adjacent the vehicle.

In a number of variations of the invention a powered rear lift 28 may be provided to lift the containers from the ground or street level up to one or more inclined ramp surfaces described hereafter.

A number of variations of the invention are illustrated in FIG. 2 and may include a vehicle 10 having a first row 30 of containers and a second row 32 of containers positioned in a cargo area 14 of the vehicle. The first row 30 of containers may include one or more containers 16 positioned on a first inclined ramp surface 34. The first inclined ramp surface 34 may be provided on a first ramp 36 in the cargo area. The first ramp 36 may be stationary or may be selectively moved, for example, by an electric, hydraulic, or a pneumatic piston connected to the first ramp to raise a first end 38 near the rear 15 of the cargo area above an opposite second end 40 nearest the front 17 of the cargo area. The first end 38 of the first ramp 36 may be elevated a distance or height H1 above the ground 26 on which the vehicle 10 rests. The lower end 40 is positioned a distance or height H2 above the ground 26 on which the vehicle 10 rests so that the distance or height H1 is greater than H2. The second row 32 of containers 16 may include at least one container on a second inclined ramp surface shown by fandom line 42. The second inclined ramp surface may also be formed by a second ramp similarly constructed as the first ramp 36. The second inclined ramp surface 42 may be operatively arranged adjacent an upper side 44 of an unloading stage 46 (best seen in FIG. 4).

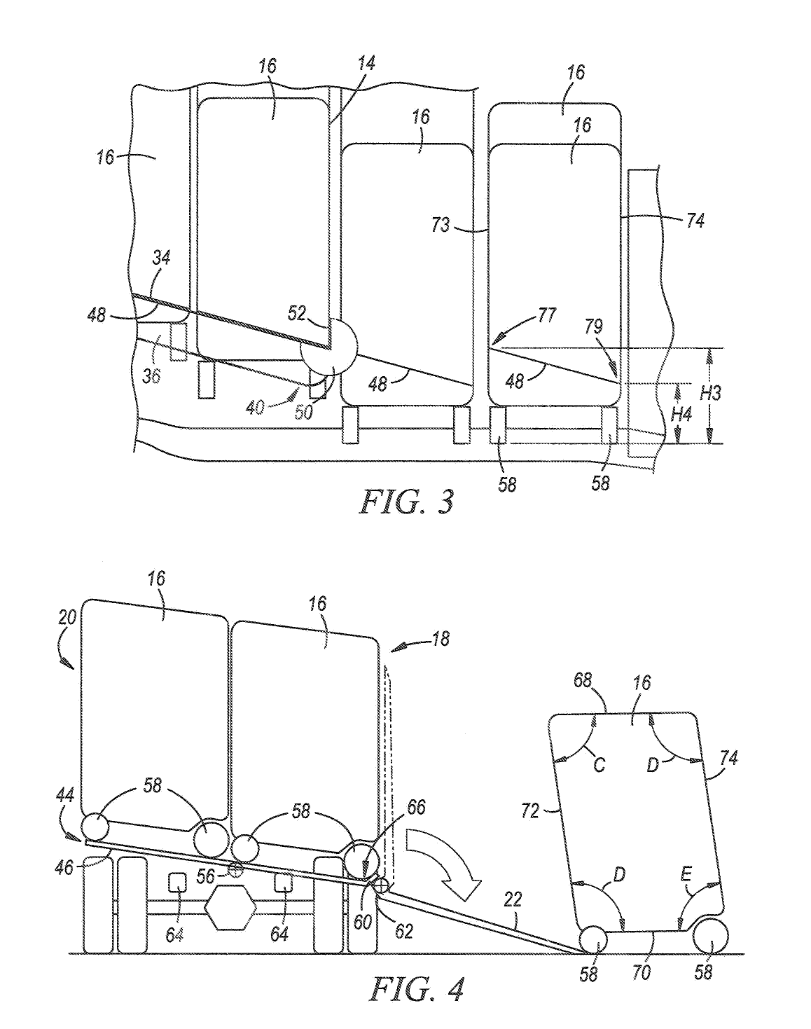

Referring now to FIG. 3, the container 16 may include an inclined support feature 48 formed on a lower surface of the container 16 to allow the container to slide along the inclined ramp surface 34. In a number of variations the inclined support feature 48 may extend from a third side 73 to a forth side 74 of the container 16. A first end 77 of the inclined support feature 48 may be positioned at a distance or height H3 above the surface on which the container 16 rests and a second end 79 of the inclined support feature 48 is positioned a distance or height H4 above the surface on which the container 16 rests so that distance or height H3 is greater than H4. A stop 50 may be provided near the second end 40 of the first ramp 36. A similar stop may be provided for the second ramp. The stop 50 may be stationary or may rotate or may be retracted to selectively prevent the containers 16 from sliding onto the unloading stage 46. In at least one variation, the stop 50 may be a cog or a cam having a recess 52 formed therein constructed and arranged to engage a side 74 of the container 16.

Referring now to FIG. 4, a number of variations of the invention may include an unloading stage 46 that is tilted from one side 20 of the vehicle toward the other side 18 of the vehicle. In a number of variations the unloading stage 46 may be fixed in a tilted position. In a number of other variations, the unloading stage 46 may be pivotally attached to the vehicle, for example, by a pivot joint 56 positioned along the unloading stage 46 at a distance from a first side 44. The container 16 may include a plurality of wheels or rollers 58. In a number of variations of the invention the wheels or rollers 58 may rotate to move the container 16 in a forward and backward direction and may also be pivotally connected to the container so that the container may be moved 360 degrees on the surface on which the container rests. A stop 60 may be provided on the unloading stage 46 to prevent the containers from rolling off of the unloading stage 46. The stop 60 may be permanently fixed, or may be retracted or moved out a position so that the containers 16 may be roiled off of the unloading stage 46. The container 16 may be pulled over a fixed stop 60 when it is desirable to unload the containers from the unloading stage 46. A side ramp 22 may be provided and may be operatively connected to the unloading stage 46. The side ramp 22 may slide underneath the unloading stage 46 or be stored in another location of the vehicle and connected to the unloading stage 46 as desired. In a number of embodiments the ramp 22 may be pivotally connected to the vehicle, for example, by a pivot joint or hinge 62. The unloading stage 46 may be tilted by an electric, hydraulic, or a pneumatic piston which may be connected to the frame 64 of the vehicle or other suitable support structure and to the unloading stage 46 to lower and raise a first side 44 of the unloading stage 46. Alternatively, electric, hydraulic, pneumatic piston or other power assist device may be connected to the frame 64 or other support structure of the vehicle to raise and lower a second side 66 of the unloading stage 46.

The containers 16 may include a top 68, a bottom 70 and a plurality of sides including a first side 72 and an opposite second side 74. The first side 72 and the opposite second side 74 may be generally parallel so that the container has a parallelogram-shape in cross-section. The angles C and D formed by top and the first side 72 and the opposite second side 74 respectively, are not equal, and/or the angles D and E formed by the bottom in the first side 72 and the opposite second side 74 respectively, are not equal.

FIGS. 1-4 illustrates a number of variations of the invention, which may include a method of delivering and picking up cargo containers 16 from at least a first facility and a second facility on a delivery route. The vehicle 10 may be equipped with a first inclined ramp surface and a second inclined ramp surface positioned in parallel in the cargo area of a vehicle. The first inclined ramp surface and the second inclined ramp surface may have a raised end near the rear the vehicle and a lower end positioned adjacent the tilted unloading stage. A plurality of cargo containers 16 may be loaded into the vehicle from the rear 15 the vehicle and placed on the first inclined ramp surface or the second inclined ramp surface so that gravity feeds the cargo containers towards the lower end of the first inclined ramp surface or the second inclined ramp surface. The cargo containers may been be moved from the first inclined ramp surface and/or second inclined ramp surface onto the tilted unloading stage. The cargo containers may be full of a variety of materials including, but not limited to, letters, packages or other goods. The full containers may be delivered to at least a first facility and a second facility an empty containers may be picked up from one or more facility and loaded onto the vehicle from the rear of the vehicle and allowed to slide down at least one of the first inclined ramp surface or second inclined ramp surface Alternatively, the cargo containers may be empty and may be delivered to at least the first facility and the second facility and wherein cargo containers with goods therein may be picked up from at least one of the facilities and loaded onto the vehicle from the rear the vehicle and allowed slide down at least one of the first inclined ramp surface or the second inclined ramp surface. In a number of variations of the invention the containers may be arranged in the vehicle without an aisle way between containers. In a number of variations, the method may include moving at least a first cargo container down the tilted unloading stage and unloading the first cargo container from the vehicle to provide an open space on the unloading stage for receiving at least one container on the inclined ramp surface, and moving a second container from the inclined ramp surface into the open space on the unloading stage. The moving of the second container from the inclined ramp surface into the open space on the unloading stage may leave an open space on the at least one inclined ramp surface for receiving a third container on the at least one inclined ramp surface. A third container may be moved into the open space on the at least one inclined ramp surface. The moving of the third container into the open space on the at least one inclined ramp surface may include moving the third container onto a powered rear lift and lifting the third container using the powered rear lift and moving the third container from the powered lift into the open space on the at least one inclined ramp surface.

The method may include moving the vehicle to a second facility, moving the second container down the tilted unloading stage and unloading the second cargo container from the vehicle to provide an open space on the unloading stage for receiving at least one container on the inclined ramp surface, and moving a third container from the inclined ramp surface into the open space on the unloading stage, picking up a fourth container from the second facility and moving the fourth container into the open space on the inclined ramp surface.

In a number of variations of the invention the gravity fed container system allows cargo containers to be moved in and out of the truck along one way that eliminate the need for an aisle way and the segregation of loading and unloading operations, and provides faster loading and more room for cargo handlers to work.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising a vehicle including a cargo area, the vehicle comprising at least one of a titled unloading stage in the cargo area or at least one inclined ramp surface in the cargo area, the at least one inclined ramp surface being constructed and arranged to allow cargo containers to slide or move along the at least one inclined ramp surface from the rear of the cargo area towards the front of the cargo area, and wherein the tilted unloading stage is constructed and arranged to allow containers to be moved down the tilted unloading stage and unloaded from the vehicle.

Variation 2 may include a product as set forth in Variation 1 wherein the vehicle comprises the at least one inclined ramp surface.

Variation 3 may include a product as set forth in any of Variations 1-2 wherein the vehicle includes the tilted unloading stage.

Variation 4 may include a product as set forth in any of Variations 1-3 wherein the vehicle comprises the at least one inclined ramp surface and the tilted unloading stage, and wherein the tilted unloading stage is positioned adjacent one end of the at least one inclined ramp surface.

Variation 5 may include a product as set forth in any of Variations 1-4 further comprising a stop connected to the at least one inclined ramp surface to prevent containers on the inclined surface from sliding onto the unloading stage of the cargo area when containers is being unloaded from the unloading stage.

Variation 6 may include a product as set forth in any of Variations 1-5 wherein the at least one inclined ramp surface comprises a first inclined ramp surface and a second inclined ramp surface.

Variation 7 may include a product as set forth in any of Variations 1-6 wherein the vehicle comprises a powered rear lift for lifting cargo containers from ground up to the at least one inclined ramp surface.

Variation 8 may include a product as set forth in any of Variations 1-7 further comprising a side ramp positioned adjacent the unloading stage and having a free end for supporting the side ramp on the ground or other surface adjacent the vehicle.

Variation 9 may include a product as set forth in any of Variations 1-8 wherein a side ramp is pivotally connected to the unloading stage.

Variation 10 may include a product as set forth in any of Variations 1-9 wherein the titled unloading stage is fixed on the vehicle in a titled position.

Variation 11 may include a product as set forth in any of Variations 1-10 wherein the titled unloading stage includes a first side adjacent a first side of the vehicle and a second side adjacent a second side of the vehicle and wherein the titled unloading stages is pivotally connected to the vehicle so the first side or the second side of the titled unloading stage to raise or lower the same.

Variation 12 may include a product as set forth in any of Variations 1-11 further comprising a plurality of cargo containers each including an inclined support features formed on lower load surfaces of the container for mating with an inclined ramp surface in the cargo area of a vehicle.

Variation 13 may include a product as set forth in any of Variations 1-12 wherein each of the plurality of the cargo containers has a plurality of sides, a top and a bottom, and wherein containers have a parallelogram-shape in cross-section wherein two opposed parallel sides of the container form angles with one of the top or bottom, and wherein the angles are not equal.

Variation 14 may include a product comprising a cargo container including a first side and an opposite second side, a third side and an opposite fourth side, an inclined support feature formed on lower load surfaces of the container at a location between the third side and the forth side and constructed and arranged for mating with an inclined ramp surface in a cargo area of a vehicle.

Variation 15 may include a product as set forth in Variation 14 wherein the inclined support feature extends from the third side to the fourth side.

Variation 16 may include a product as set forth in any of Variations 1-14 wherein the cargo container further comprises, a top or a bottom connected to the first side and the second side of the container so that the container has a parallelogram-shape in cross-section, wherein the first side and the second side are parallel and wherein the first side forms a first angle with one of the top or bottom, wherein the second side forms a second angle with one of the top or bottom and wherein the the first angle and the second angle are not equal.

Variation 17 may include a method comprising: providing a vehicle including a cargo area, the vehicle comprising at least one of a titled unloading stage in the cargo area or at least one inclined ramp surface in the cargo area, the at least one inclined ramp surface being constructed and arranged to allow cargo containers to slide or move along the at least one inclined ramp surface from the rear of the cargo area towards the front of the cargo area, and wherein the tilted unloading stage is constructed and arranged to allow containers to be moved down the tilted unloading stage and unloaded from the vehicle; sliding or moving cargo containers along the at least one inclined ramp surface from the rear of the cargo area toward the front of the cargo area, or moving cargo containers down the tilted unloading stage and unloading the cargo containers from the vehicle.

Variation 18 may include a method as set forth in Variation 17 wherein the vehicle includes the at least one inclined ramp surface and the tilted unloading stage, and wherein the tilted unloading stage is positioned adjacent a lower end of the at least one inclined ramp surface, and moving at least a first cargo container down the tilted unloading stage and unloading the first cargo container from the vehicle to provide an open space on the unloading stage for receiving at least one container on the inclined ramp surface, and moving a second container from the inclined ramp surface into the open space on the unloading stage.

Variation 19 may include a method as set forth in any of Variations 17-18 wherein the moving the second container from the inclined ramp surface into the open space on the unloading stage leaves an open space on the at least one inclined ramp surface for receiving a third container on the at least one inclined ramp surface, further comprising moving a third container into the open space on the at least one inclined ramp surface.

Variation 20 may include a method as set forth in any of Variations 17-19 further comprising delivering the first container to a first facility, and picking up the third container from the first facility.

Variation 21 may include a product as set forth in any of Variations 17-20 wherein the vehicle further comprises a powered rear lift, and wherein the moving a third container into the open space on the at least one inclined ramp surface comprises moving the third container onto the powered rear lift and lifting the third container using the powered rear lift and moving the third container from the powered lift into the open space on the at least one inclined ramp surface.

Variation 22 may include a product as set forth in any of Variations 17-21 further comprising moving the vehicle to a second facility, moving the second container down the tilted unloading stage and unloading the second cargo container from the vehicle to provide an open space on the unloading stage for receiving at least one container on the inclined ramp surface, and moving a third container from the inclined ramp surface into the open space on the unloading stage, picking up a fourth container from the second facility and moving the fourth container into the open space on the inclined ramp surface.

Variation 23 may include a method of loading and unloading cargo containers using a product as set forth in any of Variations 1-16.

The above description of select examples of the invention is merely exemplary in nature and, thus, variations or variants thereof are not to be regarded as a departure from the spirit and scope of the invention.

1. A product comprising a vehicle including a cargo area, the vehicle comprising at least one of a titled unloading stage in the cargo area or at least one inclined ramp surface in the cargo area, the at least one inclined ramp surface being constructed and arranged to allow cargo containers to slide or move along the at least one inclined ramp surface from the rear of the cargo area towards the front of the cargo area, and wherein the tilted unloading stage is constructed and arranged to allow containers to be moved down the tilted unloading stage and unloaded from the vehicle.

2. A product as set forth in claim 1 wherein the vehicle comprises the at least one inclined ramp surface.

3. A product as set forth in claim 1 wherein the vehicle includes the tilted unloading stage.

4. A product as set forth in claim 1 wherein the vehicle comprises the at least one inclined ramp surface and the tilted unloading stage, and wherein the tilted unloading stage is positioned adjacent one end of the at least one inclined ramp surface.

5. A product as set forth in claim 1 further comprising a stop connected to the at least one inclined ramp surface to prevent containers on the inclined surface from sliding onto the unloading stage of the cargo area when containers is being unloaded from the unloading stage.

6. A product as set forth in claim 2 wherein the at least one inclined ramp surface comprises a first inclined ramp surface and a second inclined ramp surface.

7. A product as set forth in claim 2 wherein the vehicle comprises a powered rear lift for lifting cargo containers from ground up to the at least one inclined ramp surface.

8. A product as set forth in claim 2 further comprising a side ramp positioned adjacent the unloading stage and having a free end for supporting the side ramp on the ground or other surface adjacent the vehicle.

9. A product as set forth in claim 8 wherein the side ramp is pivotally connected to the unloading stage.

10. A product as set forth in claim 3 wherein the titled unloading stage is fixed on the vehicle in a titled position.

11. A product as set forth in claim 3 wherein the titled unloading stage includes a first side adjacent a first side of the vehicle and a second side adjacent a second side of the vehicle and wherein the titled unloading stages is pivotally connected to the vehicle so the first side or the second side of the titled unloading stage to raise or lower the same.

12. A product as set forth in claim 2 further comprising a plurality of cargo containers each including an inclined support features formed on lower load surfaces of the container for mating with an inclined ramp surface in the cargo area of a vehicle.

13. A product as set forth in claim 12 wherein each of the plurality of the cargo containers has a plurality of sides, a top and a bottom, and wherein containers have a parallelogram-shape in cross-section wherein two opposed parallel sides of the container form angles with one of the top or bottom, and wherein the angles are not equal.

14. A product comprising a cargo container including a first side and an opposite second side, a third side and an opposite fourth side, an inclined support feature formed on lower load surfaces of the container at a location between the third side and the forth side and constructed and arranged for mating with an inclined ramp surface in a cargo area of a vehicle.

15. A product as set forth in claim 13 wherein the inclined support feature extends from the third side to the fourth side.

16. A product as set forth in claim 13 wherein the cargo container further comprises, a top or a bottom connected to the first side and the second side of the container so that the container has a parallelogram-shape in cross-section, wherein the first side and the second side are parallel and wherein the first side forms a first angle with one of the top or bottom, wherein the second side forms a second angle with one of the top or bottom and wherein the first angle and the second angle are not equal.

17. A method comprising:
providing a vehicle including a cargo area, the vehicle comprising at least one of a titled unloading stage in the cargo area or at least one inclined ramp surface in the cargo area, the at least one inclined ramp surface being constructed and arranged to allow cargo containers to slide or move along the at least one inclined ramp surface from the rear of the cargo area towards the front of the cargo area, and wherein the tilted unloading stage is constructed and arranged to allow containers to be moved down the tilted unloading stage and unloaded from the vehicle;
sliding or moving cargo containers along the at least one inclined ramp surface from the rear of the cargo area toward the front of the cargo area, or moving cargo containers down the tilted unloading stage and unloading the cargo containers from the vehicle.

18. A method as set forth in claim 17 wherein the vehicle includes the at least one inclined ramp surface and the tilted unloading stage, and wherein the tilted unloading stage is positioned adjacent a lower end of the at least one inclined ramp surface, and moving at least a first cargo container down the tilted unloading stage and unloading the first cargo container from the vehicle to provide an open space on the unloading stage for receiving at least one container on the inclined ramp surface, and moving a second container from the inclined ramp surface into the open space on the unloading stage.

19. A method as set forth in claim 18 wherein the moving the second container from the inclined ramp surface into the open space on the unloading stage leaves an open space on the at least one inclined ramp surface for receiving a third container on the at least one inclined ramp surface, further comprising moving a third container into the open space on the at least one inclined ramp surface.

20. A method as set forth in claim 20 further comprising delivering the first container to a first facility, and picking up the third container from the first facility.
